(19) United States
(12) Patent Application Publication
(10) Pub. No.: US 2011/0162254 A1
(43) Pub. Date: Jul. 7, 2011

(54) A FISHING LURE

(75) Inventor: Ronald Cornelius Smits, Queensland (AU)

(73) Assignee: SMITS INVESTMENTS (AUST) PTY. LTD, Queensland (AU)

(21) Appl. No.: 13/061,604

(22) PCT Filed: May 27, 2010
(86) PCT No.: PCT/AU2010/000646

§ 371 Date: Mar. 1, 2011

(30) Foreign Application Priority Data
May 29, 2009 (AU) 2009902448

(51) Int. Cl. A01K 85/00

(52) U.S. Cl. 43/42.36; 43/42.49; 43/42.53

(57) ABSTRACT

A fishing lure (10) includes a lure mounting arrangement (12) for mounting on a fishing line (14) and a lure movement altering body (18) that is detachably mountable on the lure mounting arrangement (12) for influencing movement of the lure (10) when it is displaced through water. The lure movement altering body (18) has an outer surface and defines a longitudinally extending body passage (20) therein. The body (18) also includes a longitudinal fishing line opening (21) communicating with the body passage (20) that opens onto the outer surface thereof. The movement altering body (18) is mountable on and dismountable from the lure mounting arrangement (12) by a movement that is transverse to the longitudinal direction of the body passage (20). Further the fishing line (14) can be passed through the fishing line opening (21) into or out of the body passage (20) when the movement altering body (18) is mounted on or dismounted from the lure mounting arrangement (12).

### FIELD OF THE INVENTION

This invention relates to a fishing lure and to a method of altering movement of a fishing lure that is to be dragged, in use, through water.

The invention relates particularly but not exclusively to an offshore trolling lure, such as a skirted offshore lure of the type resembling an octopus or a squid.

### BACKGROUND TO THE INVENTION

A known skirted offshore lure generally includes a leading rigid lure portion (lure head portion) and a trailing elongated flexible lure portion (lure skirt portion) attached towards a trailing end of the head portion. The elongated flexible lure portion can be formed from a plurality of elongated flexible tentacle-like formations of which same side ends are attached to the head portion. Typically, the head portion defines a relatively narrow elongated passage extending in a fore-and-aft direction through the lure head portion, through which the fishing line is passed in use.

Some of the more common types of lure heads can be broadly classified according to the manner in which they move in use, and their characteristic shapes, or other functions. Some of these more common types of lure heads are referred to as tubes, bullets, plungers, konaheads, jets, pushers, and chuggers.

A person skilled in the art of fishing will appreciate that it may require a trial and error procedure that involves experimenting with different lures having different properties to find a lure that is well suited to prevailing fishing conditions, and to a target species of fish that an angler is trying to catch, during a fishing session. For an angler to substitute one lure for another lure while they are engaged in fishing, the fishing hook has to be removed from the fishing line, and the entire fishing lure has to be exchanged with another fishing lure. It will readily be appreciated that this may be a time consuming exercise. Clearly therefore it would be advantageous if ways could be devised for altering the movement of a fishing lure in a relatively quick and uncomplicated manner.

Another shortcoming of known fishing lures is that they can be expensive. Therefore it would be advantageous if a system in which the number of complete lures that are required be purchased by an angler to provide a complement of lure types that would enable them to fish effectively could be reduced. This would reduce the cost to an angler properly equipping themselves with lures.

Yet further anglers are always looking for more effective fishing aids and accessories to give them a greater advantage in catching a fish. Generally this involves devising features that enable the lure to more faithfully and accurately mimic the behaviour and movement of a fish that is prey for the target fish that is desired to be caught.

Clearly it would be advantageous if a fishing lure that ameliorates some of the shortcomings described above could be devised.

### SUMMARY OF THE INVENTION

According to a first aspect of the invention there is provided a fishing lure, including: a lure mounting arrangement for attaching to a fishing line; a lure movement altering body for influencing movement of the lure when it is displaced through water, that is detachably mountable on the lure mounting arrangement, the lure movement altering body having an outer surface and defining a longitudinally extending body passage therein, and a longitudinal fishing line opening communicating with the body passage that opens onto the outer surface thereof; and wherein the movement altering body, is mountable on and dismountable from, the lure mounting arrangement by a movement that is transverse to the longitudinal direction of the body passage, and wherein a fishing line that is operatively coupled to the lure mounting arrangement can be passed through the fishing line opening into or out of the body passage when the movement altering body is mounted on or dismounted from the lure mounting arrangement.

The movement altering body may include two opposing end walls and a side wall extending between the end walls, e.g. a substantially cylindrical side wall. The body passage may have body passage openings that open onto each end wall.

The fishing line opening may extend substantially the full length of the side wall and may also extend across the end walls to the body passage whereby to enable the fishing line that is positioned outside of the movement altering body to be inserted through the fishing line opening into the body passage with the fishing line projecting out of the fishing line openings at the ends of the body.

The body passage may be sized so that fishing line is receivable therein with some clearance whereby to enable the body to be slid along the fishing line without significant resistance. The fishing line opening may have a width that is sized to receive a fishing line there through with a working clearance.

The fishing line opening may extend in a non-linear fashion along the side wall and may be curved along at least part of its length. In one form the fishing line opening may have a substantially S-shaped configuration.

The lure mounting arrangement may define a mounting formation on an outward facing surface on the lure mounting arrangement, and the movement altering body has an inward facing surface defining the body passage which may form a complementary engagement formation within which the mounting formation is snugly received.

The mounting formation may comprise a spigot and the complementary engagement formation may comprise a socket that receives the spigot.

The mounting formation and the complementary engagement formation may have complementary clip formations for detachably clipping the formations together when the mounting formation is fully received within the complementary engagement formation. The complementary clip formations may comprise complementary male and female clip formations.

The lure mounting arrangement may include a leading mounting part, and a trailing mounting part, and the leading and trailing mounting parts may be coupled to each other in a way that permits them to move relative to each other.

The leading mounting part may define a leading part passage there through and the trailing mounting part may define a trailing part passage there through and the leading and trailing part passages may aligned with each other so that the fishing line can be passed there through.

The lure mounting arrangement may include a swivel operatively coupling the leading mounting part to the trailing mounting part, whereby the leading mounting part and the trailing mounting part may be capable of swivelling relative to each other about a swivelling axis, e.g. which is co-axial with the leading and trailing part passages. The lure mounting arrangement may include a bearing interposed between the trailing and leading mounting parts whereby to permit the parts to swivel freely relative to each other.

The leading mounting part may form the spigot which engages with the socket on the movement altering body. The spigot may have a spigot leading end and a spigot trailing end and two major surfaces extending between the leading and trailing ends.

The leading mounting part may include two transversely outward facing eye depicting formations that are mounted on the major surfaces of the spigot.

The spigot may comprise a two component construction comprising an inner support and an outer cover which is mounted over the inner support. The outer cover may be substantially transparent.

The spigot may also include a reflective element for reflecting incident light therefrom. The reflective element may be in the form of a sheet material that is mounted over the major surfaces of the spigot.

The fishing lure may include an elongated flexible lure portion that is mounted on the trailing mounting part. The elongated flexible lure portion may include a plurality of elongated flexible tentacle-like formations of which same side ends are attached to the trailing mounting part of the lure mounting arrangement.

The movement altering body may be shaped and sized for effecting a desired movement of the lure when the lure is dragged, in use, through water. The movement altering body may be one of the following: a generally circular cylindrical body having a leading face and a trailing end, and a mouth of the socket opening at the trailing end of the movement altering body; a body which bulges in a radial outward direction so that a leading end portion of the movement altering body converges or tapers inwardly towards the leading face; a leading face that bulges axially outwardly, so that the outer surface of the movement altering body is shaped in a way that is characteristic of an offshore bullet head-type lure head; a leading face that slants transversely, so that the outer surface of the movement altering body is shaped in a way that is characteristic of a tube-type lure head; a leading face that slants transversely and a front end portion that converges towards the front face, so that the outer surface of the movement altering body is shaped in a way that is characteristic of a konahead-type lure head; a leading face that is axially inwardly concave, so that the outer surface of the movement altering body is shaped in a way that is characteristic of a chugger-type lure head; and a leading face that is transversely orthogonally flat, so that the outer surface of the movement altering body is shaped in a way that is characteristic of a pusher-type lure head.

The movement altering body may define at least one water agitating passage extending broadly longitudinally therein through which water may pass, when the lure is dragged through the water creating an air bubble trail. Each agitating passage may form a jet head. The movement altering body may define a plurality jet heads spaced apart from each other. The diameter of the longitudinally extending passages forming the jet heads may be varied to vary the nature or characteristics of the bubble trail that is generated.

According to another aspect of the invention there is provided a lure movement altering arrangement for a fishing lure including a lure mounting arrangement that is attachable to a fishing line, the lure movement altering arrangement including:

a lure movement altering body for influencing movement of the lure when it is displaced through water, that is detachably mountable on the lure mounting arrangement, the lure movement altering body having an outer surface and defining a longitudinally extending body passage therein, and a longitudinal fishing line opening communicating with the body passage that opens onto the outer surface thereof; and wherein the movement altering body, is mountable on and dismountable from, the lure mounting arrangement by a movement that is transverse to the longitudinal direction of the body passage, and wherein a fishing line that is operatively coupled to the lure mounting arrangement can be passed through the fishing line opening into or out of the body passage when the movement altering body is mounted on or dismounted from the lure mounting arrangement.

The lure movement altering body may include two opposing end walls and a substantially cylindrical side wall extending between the end walls, e.g. a substantially cylindrical side wall.

The body passage may have body passage openings that open onto each end wall, and the fishing line opening may extend substantially the full length of the side wall and across the end walls to the body passage into which it opens, whereby to enable a fishing line that is positioned outside of the movement altering body to be inserted through the fishing line opening into the body passage with the fishing line projecting out of the fishing line openings at the ends of the body.

The fishing line opening may extend in a non-linear fashion along the side wall substantially the full length of the side wall.

The lure movement altering body may include any one or more of the features of the body defined in the first aspect of the invention.

According to another aspect of the invention there is provided a lure mounting arrangement for a fishing lure having a lure movement altering body having an outer surface and defining a longitudinally extending body passage therein, and having a longitudinal fishing line opening communicating with the body passage and opening onto the outer surface thereof, the lure mounting arrangement including:

a mounting body including a mounting formation that is receivable within a complementary engagement formation formed by at least part of the body passage.

The mounting body may include a leading mounting part defining said mounting formation and a trailing mounting part, and the leading and trailing mounting parts may be coupled to each other in a way that they are capable of movement relative to each other.

The lure mounting arrangement may include a swivel operatively coupling the leading mounting part to the trailing mounting part, whereby the leading mounting part and the trailing mounting part may be capable of swivelling relative to each other about a swivelling axis. The lure mounting arrangement may include a bearing interposed between the trailing and leading mounting parts whereby to permit the parts to swivel freely relative to each other.

The mounting formation may comprise a spigot.

The lure mounting arrangement may include an elongated flexible lure portion that is mounted on the trailing mounting part.

The lure mounting arrangement may include any one or more of the features of the body defined in the first aspect of the invention.

According to another aspect of the invention, for a fishing lure comprising a lure mounting arrangement that is mounted on a fishing line and a lure movement altering body that is detachably mounted on the lure mounting arrangement, there is provided a method of modifying the movement of the fishing lure through water during fishing, including: detaching said movement altering body from the lure mounting arrangement; and detachably mounting a different movement altering body on the lure mounting arrangement whereby to modify the manner in which the fishing lure moves when displaced through water.

The lure movement altering body may have a longitudinally extending body passage defined therein and an outer surface with a longitudinal fishing line opening defined therein, and detaching the movement altering body may include passing the fishing line through the fishing line opening, and mounting said other movement altering body may include passing the fishing line in through the fishing line opening.

Detaching said one lure movement altering body from the lure mounting arrangement may also include displacing the lure movement altering body in a translational fashion in a direction away from the lure mounting arrangement.

Mounting said other lure movement altering body on the lure mounting arrangement may include displacing the lure movement altering body in a translational fashion in a direction towards the lure mounting arrangement.

The other lure movement altering body and the lure mounting arrangement may have complementary clip formations, and mounting said other lure movement altering body on the lure mounting arrangement may include displacing the lure movement altering body in a translational fashion towards the lure mounting arrangement until the complementary clip formations engage each other.

Detaching said one lure movement altering body from the lure mounting arrangement may include detaching a body chosen from the group including: a generally circular cylindrical body having a leading face and a trailing end, and a mouth of the socket opening at the trailing end of the movement altering body; a body which bulges radially outwardly so that a leading end portion of the movement altering body converges or tapers inwardly towards the leading face; a leading face that bulges axially outwardly, so that the outer surface of the movement altering body is shaped in a way that is characteristic of an offshore bullet head-type lure head; a leading face that slants transversely, so that the outer surface of the movement altering body is shaped in a way that is characteristic of a tube-type lure head; a leading face that slants transversely and a front end portion that converges towards the front face, so that the outer surface of the movement altering body is shaped in a way that is characteristic of a konahead-type lure head; a leading face that is axially inwardly concave, so that the outer surface of the movement altering body is shaped in a way that is characteristic of a chugger-type lure head; and a leading face that is transversely orthogonally flat, so that the outer surface of the movement altering body is shaped in a way that is characteristic of a pusher-type lure head.

Detachably mounting said other lure movement altering body on the lure mounting arrangement may include detachably mounting a body that is different to said one body detached from the lure mounting arrangement.

According to another aspect of the invention there is provided a method for altering the movement of a fishing lure, the method including: providing a mounting arrangement on a fishing line; and mounting selectively one of a plurality of lure movement altering bodies on the mounting arrangement, each lure movement altering body affecting unique movement of the fishing lure, in use, when the fishing lure is dragged through water, wherein the mounting arrangement includes a mounting body including a leading mounting part and a trailing mounting part; and a swivel for attaching the leading mounting part and the trailing mounting part together so that they are operatively able to swivel relative to each other about a swivelling axis.

According to another aspect of the invention there is provided a fishing lure, including: a lure mounting arrangement for attaching to a fishing line; a lure movement altering arrangement for influencing movement of the lure when it is displaced through water, that is detachably mountable on the lure mounting arrangement, the movement altering arrangement being detachable from the lure mounting arrangement by a movement of the arrangements relative to each other and wherein a fishing line that is operatively coupled to the lure mounting arrangement can be passed into or out of the lure movement altering arrangement when the movement altering arrangement is detached from the lure mounting arrangement.

The lure movement altering arrangement may have a longitudinally extending arrangement passage formed therein, and a longitudinal fishing line opening communicating with the arrangement passage that opens onto the outer surface thereof, and the lure movement altering arrangement, may be mountable on and dismountable from, the lure mounting arrangement by a movement that is transverse to the longitudinal direction of the arrangement passage, and a fishing line that is operatively coupled to the lure mounting arrangement can be passed through the fishing line opening into or out of the arrangement passage when the movement altering arrangement is mounted on or dismounted from the lure mounting arrangement.

The movement altering arrangement may be a movement altering body, e.g. a single body, include two opposing end walls and a side wall having an outer surface extending between the end walls. The body passage may have body passage openings that open onto each end wall.

Instead the movement altering arrangement may include a plurality of components operatively coupled to each other.

The invention also extends to an arrangement for assembling a fishing lure which includes: a lure mounting arrangement for mounting the fishing lure onto a fishing line; and a plurality of lure movement altering arrangements that are selectively detachably mountable onto the lure mounting arrangement, each lure movement altering arrangement being for influencing the movement of the lure when the lure is dragged, in use, through water.

The lure mounting arrangement may comprise a mounting body including a leading mounting part and a trailing mounting part; and a swivel for attaching the leading mounting part and the trailing mounting part together so that they are operatively able to swivel relative to each other about a swivelling axis.

Each of the components above may also include any one or more of the optional features of components of the lure as defined above in the first aspect of the invention. The arrangement may be in kit form.

### DETAILED DESCRIPTION OF THE PREFERRED EMBODIMENTS

A fishing lure may manifest itself in a variety of forms. It will be convenient to hereinafter describe several embodiments of the invention in detail with reference to the accompanying drawings. The purpose of providing this detailed description is to instruct persons having an interest in the subject matter of the invention how to carry the invention into practical effect. However it is to be clearly understood that the specific nature of this detailed description does not supersede the generality of the preceding broad description. In the drawings:

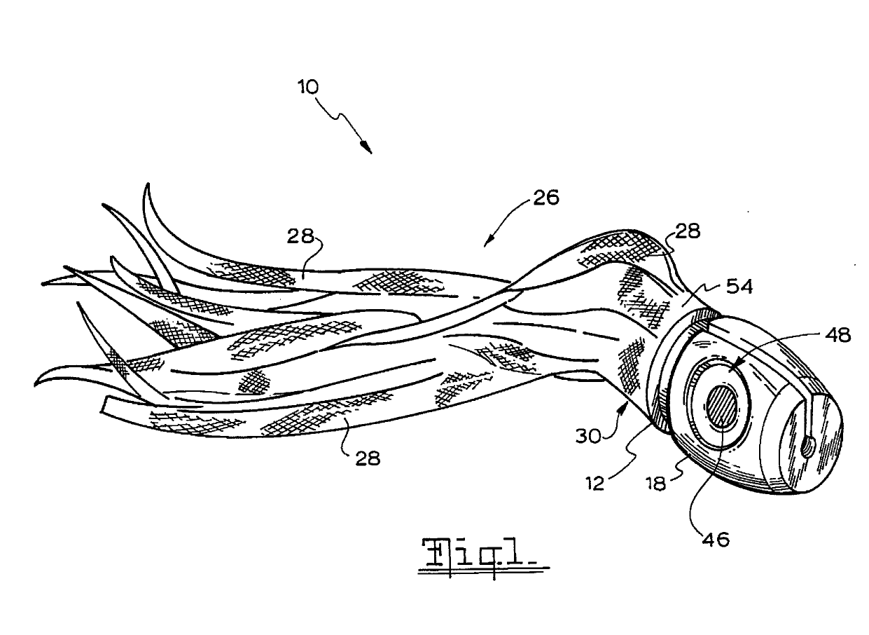

FIG. 1 shows a schematic three-dimensional view of a fishing lure, in accordance with one embodiment of the invention;

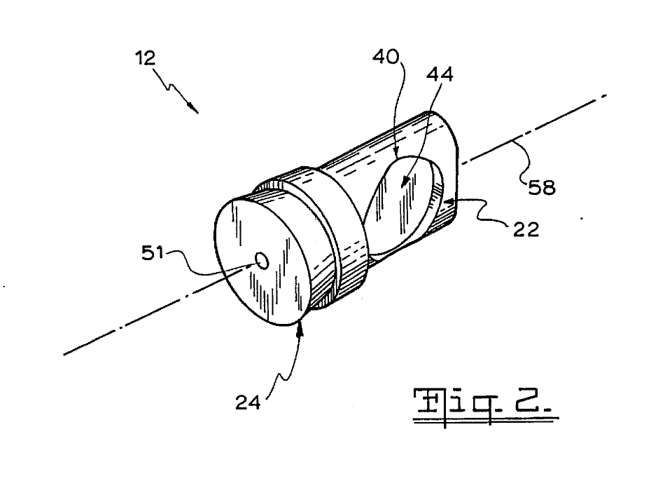

FIG. 2 shows a schematic three dimensional view of a lure mounting arrangement forming part of the fishing lure in FIG. 1;

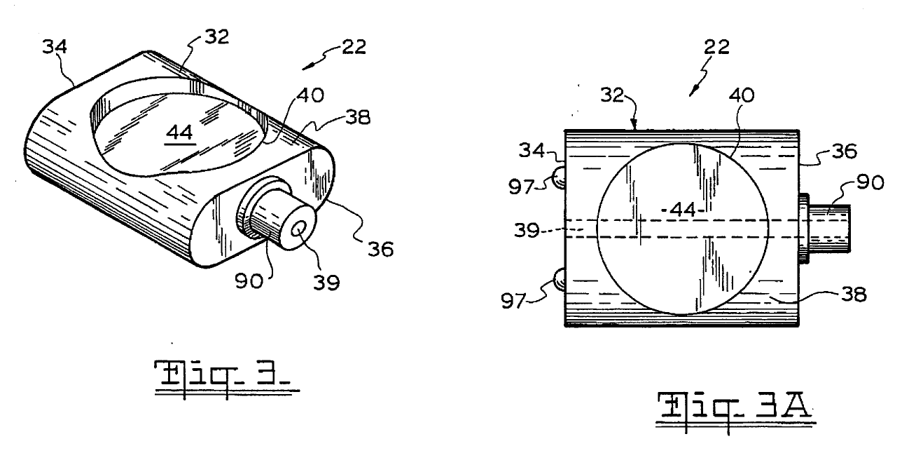

FIG. 3 shows a three dimensional view of a leading mounting part of the lure mounting arrangement in FIG. 2;

FIG. 3A shows a plan view of the leading mounting part in FIG. 3;

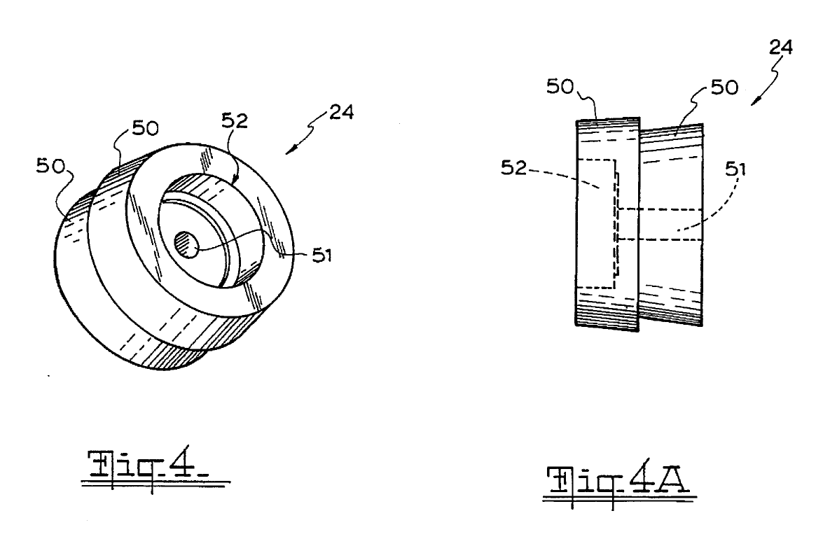

FIG. 4 shows a three dimensional view of a trailing mounting part forming part of the lure mounting arrangement in FIG. 2;

FIG. 4A shows a side elevation view of the trailing mounting part in FIG. 4;

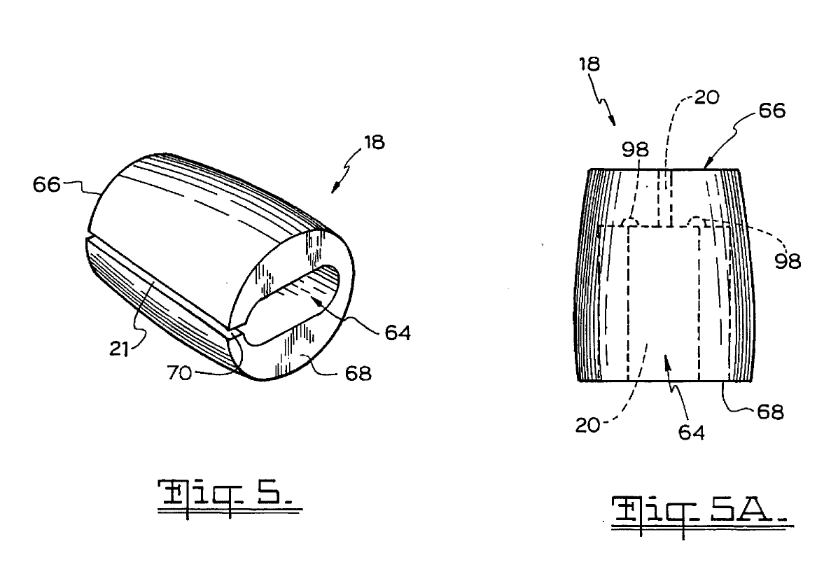

FIG. 5 shows a three dimensional view of a lure movement altering body of the fishing lure in FIG. 1;

FIG. 5A show a side elevation view of the lure movement altering body in FIG. 5;

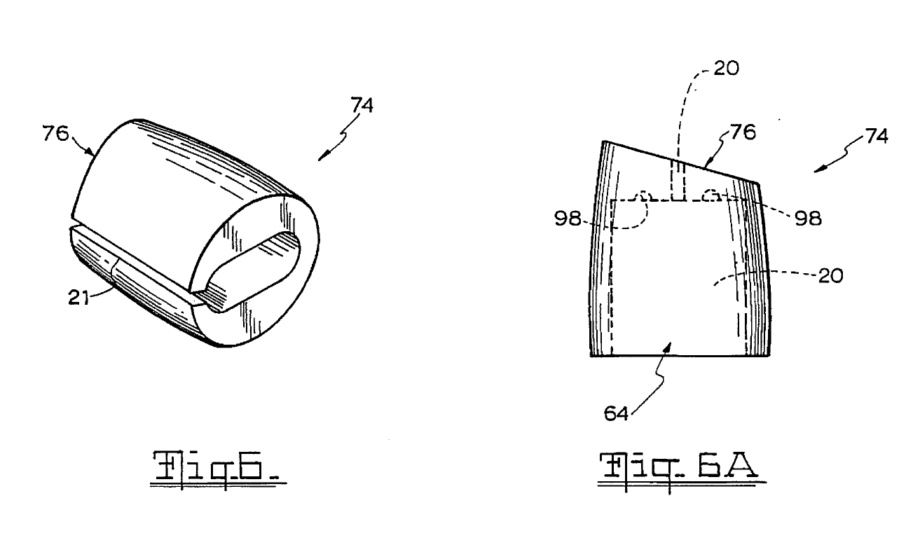

FIG. 6 shows a three dimensional view of another lure movement altering body suitable for use with the fishing lure in FIG. 1;

FIG. 6A shows a side elevation view of the lure movement altering body of FIG. 6;

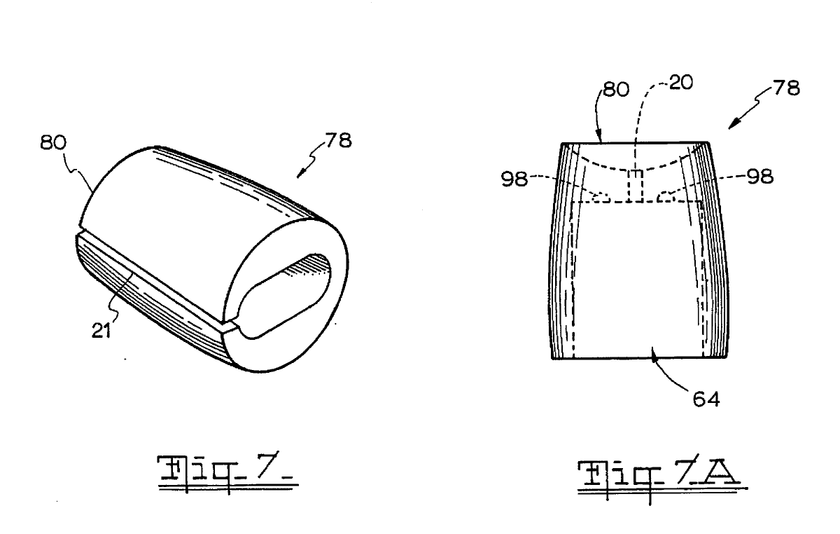

FIG. 7 shows a three dimensional view of yet another lure movement altering body suitable for use with the fishing lure in FIG. 1;

FIG. 7A shows a side elevation view of the lure movement altering body in FIG. 7;

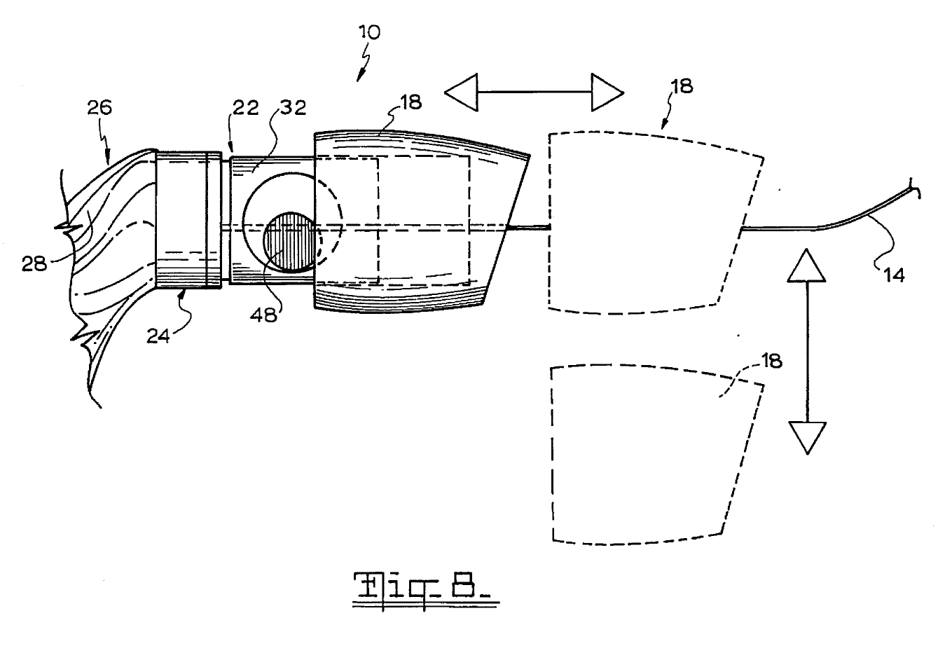

FIG. 8 shows a three dimensional view of a lure movement altering body being detachably mounted onto a lure mounting arrangement that is attached to a fishing line;

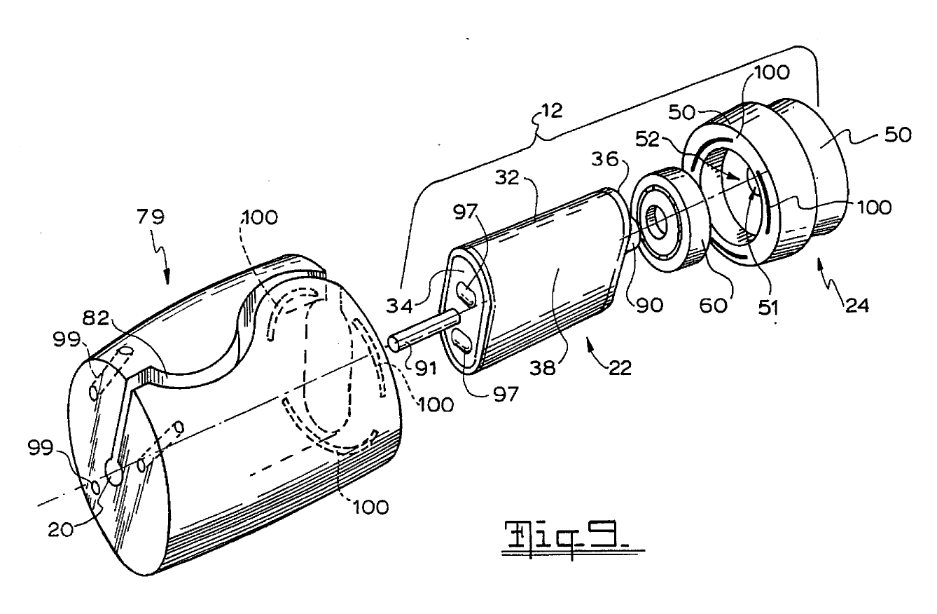

FIG. 9 shows a schematic three dimensional exploded view of a fishing lure in accordance with another embodiment of the invention;

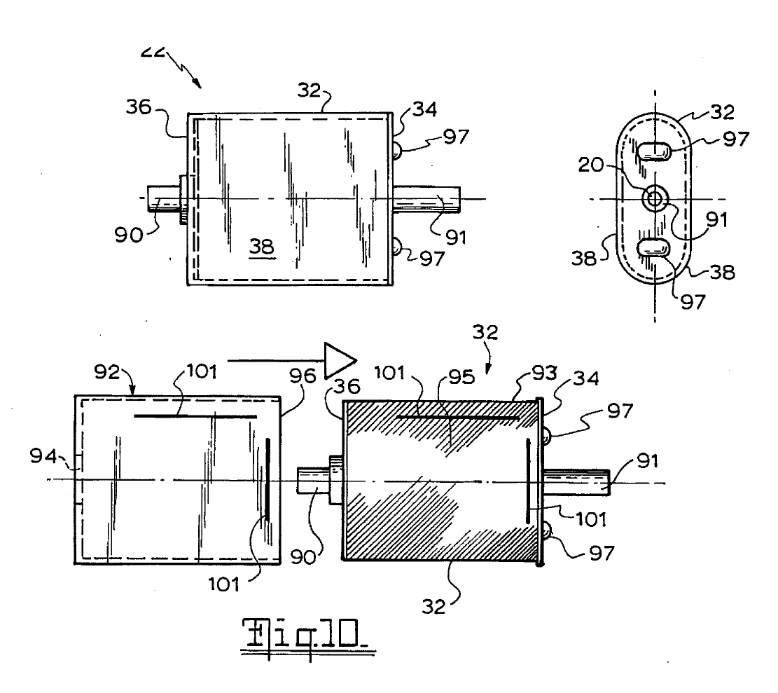

FIG. 10 shows a number of schematic views of a leading mounting part of the lure mounting arrangement of the fishing lure of FIG. 9;

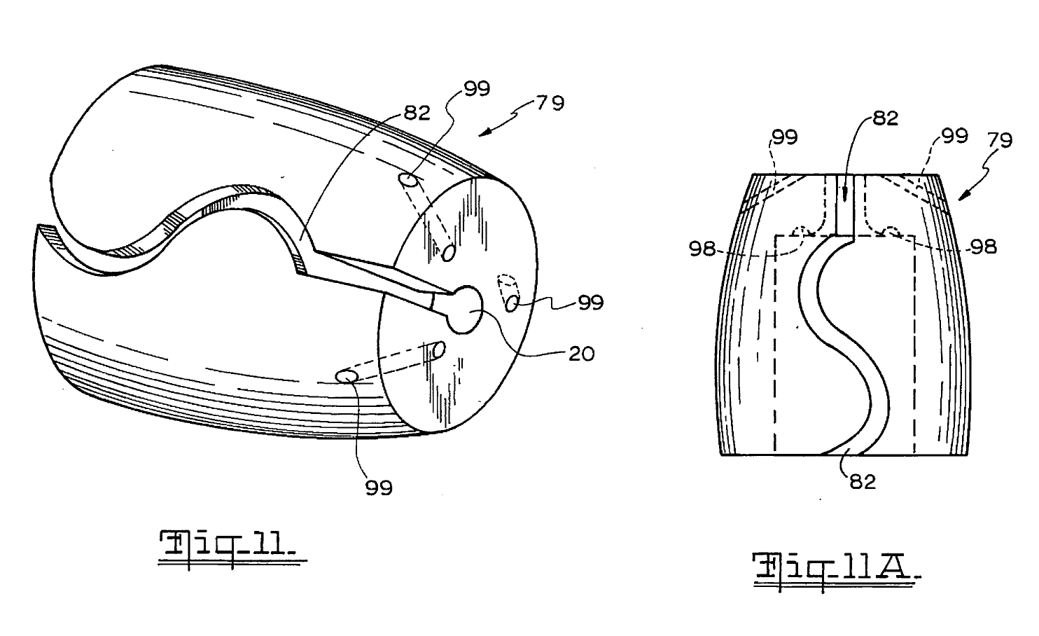

FIG. 11 shows a three dimensional view of a lure movement altering body for the fishing lure of FIG. 9; and

FIG. 11A shows a side elevation view of the lure movement altering body of FIG. 11.

In FIGS. 1 to 5 of the drawings, reference numeral 10 generally indicates a fishing lure in accordance with one embodiment of the invention. The fishing lure 10 is an offshore fishing lure for use in reel and troll fishing.

The fishing lure 10 includes a lure mounting arrangement, generally indicated by reference numeral 12, for mounting the fishing lure 10 onto a fishing line 14. The fishing lure 10 also includes a lure movement altering body, generally indicated by reference numeral 18, which is detachably mountable onto the lure mounting arrangement 12 for influencing movement of the fishing lure 10 through water.

The body 18 has an outer surface and an inner surface that defines a longitudinally extending body passage 20 therein. The body 18 also includes a longitudinal fishing line opening 21 that opens onto the outer surface of the body 18 and communicates therewith.

The lure movement altering body 18 shown in FIG. 5 has a substantially linear or rectilinear extending fishing line opening 21. The opening 21 is in the form of a longitudinal slit or slot that extends the length of the body 18 and is sized to permit a fishing line 14 to be passed there through with a small clearance. This way a section of fishing line 14 that is outside the body 18 can be passed into the body 18 through the opening 21. Similarly a section of fishing line 14 that is within the body passage 20 of the body 18 can be passed through the opening 21 and out of the body 18.

The body passage 20 defined within the body 18 is sized to enable the movement altering body 18 to be displaced in a detachable fashion over the lure mounting arrangement 12. The interaction of the longitudinally extending body passage 20 with the lure mounting arrangement 12 is described in more detail below.

The lure mounting arrangement 12 includes a mounting body comprising two mounting parts namely a leading mounting part 22 and a trailing mounting part 24 and is illustrated in some detail in FIGS. 2 to 4. The leading mounting part 22 includes a mounting formation for engaging with the movement altering body 18 as described above. In this embodiment the mounting formation is in the form of a spigot 32 having a spigot leading end 34 and a spigot trailing end 36.

The spigot 32 is in the form of a flat rectangular box shape having a side wall extending between the leading and the trailing ends 34, 36. The side wall comprises two substantially planar major surfaces 38 and two rounded side edges joining the major surfaces 38 to each other.

The spigot 32 also includes a stub 90 projecting in an axial direction away from the trailing end 36 thereof that engages indirectly with the trailing mounting portion 24.

The spigot 32 includes a leading part passage that is a spigot passage 39 that extends substantially centrally there through in a longitudinally extending direction that can receive fishing line 14 there through in use.

The spigot 32 has two outward facing fish eye depicting formations 48, on the major surfaces 38 thereof. Each eye depicting formation 48 includes a substantially circular recess formation shown generally by numeral 40 defining a recessed surface 44 in FIGS. 2 and 3. The recessed surface 44 is overlaid with a light colour. Each eye formation 48 also includes a flattened transparent bulbous formation that is mounted over the depression 40. A chamber is defined between the bulbous formation and the adjacent recessed surface 44. A flat circular disk 46 of darker colour than the surface 44 is received within the chamber and this mimics the eye of a fish.

The trailing mounting part 24 is generally circular cylindrical and includes two axially spaced barb collars 50 positioned between a leading face and a trailing face thereof. The trailing mounting part 24 also includes a trailing part passage 51 extending axially there through for receiving at least the fishing line there through in use. An axial circular depression or recess 52 is defined in the leading face of the trailing mounting part 24 surrounding the trailing part passage 51.

The lure mounting arrangement 12 also includes a swivel interposed between the leading mounting part 22 and the trailing mounting part 24.

The swivel is not shown in FIGS. 1 to 5 but is shown in FIG. 9 where it is indicated by reference numeral 60. The swivel permits the mounting parts 22 and 24 to swivel relative to each other about a swivelling axis 58 that is coaxial with a longitudinal axis of the spigot passage 39. That is they are able to be rotated independently about the fishing line 14.

The swivel is mounted over the stub 90 and is received within the circular depression 52 in the trailing mounting part 24. The swivel is formed by an annular roller bearing including an outer race and an inner race. The outer race of the roller bearing is shaped and sized to be press fitted into the circular depression 52 in the trailing mounting part 24. The inner race of the roller bearing defines a circular central opening within which the stub 90 of the leading mounting part 22 is press fitted.

The fishing lure 10 further includes an elongated flexible lure portion or skirt, generally indicated by reference numeral 26 that is mounted on the lure mounting arrangement at the point indicated by the numeral 30. The flexible lure portion 26 includes a plurality of elongated flexible tentacle-like formations 28 of which same side ends are attached to the trailing mounting part 24 of the lure mounting arrangement 12.

The elongated flexible lure portion 26 can conveniently be formed from a cylindrical resilient sheet of material that is longitudinally cut at spaced intervals across its width to form the tentacle-like formations 28. Each cut extends lengthwise along the sheet and terminates short of one end of the sleeve defining an uncut end portion of the sheet. The uncut portion defines a short sleeve 54 that is resiliently mounted over one of the barb collar formations 50.

The lure movement altering body 18 will be described in detail with reference to FIGS. 5 and 5A which show the features of the lure movement altering body 18 in some detail.

The movement altering body 18 has a leading face 66 and a trailing face 68 and a substantially cylindrical side wall extending between the leading and trailing faces, forming the outer surface thereof. The cylindrical wall has a shape that is configured to be suitable for influencing, modifying or affecting the movement of the lure 10 when the lure 10 is dragged, in use, through water. As shown in the drawings the cylindrical side wall bulges outward intermediate its ends and the leading face 66 is transversely orthogonally flat with a form that is characteristic of a pusher-type lure head.

The inner surface of the movement altering body 18 is configured to define a complementary engagement formation that is a socket 64 along at least part of the length of the body passage 20. The socket 64 is of complementary shape to the spigot 32 of the leading mounting part 22. The socket 64 has a socket mouth 70 that opens onto the trailing face 68 of the body 18.

The movement altering body 18 can be mounted on the lure mounting arrangement 12 by passing the spigot 32 into the socket 64 through the socket mouth 70.

The lure 10 also includes complementary clip formations on the spigot 32 and the lure movement altering body 18 for positively attaching or connecting the arrangement 12 and body 18 to each other. In the illustrated embodiment the complementary clip formations comprise small male formations, e.g. ridges 97, on the leading mounting part 22 which positively connect with complementary female formations, e.g. depressions 98, on the inner surface of the body 18. This ensures that the body 18 is detachably held on the leading mount part 22 when the lure 10 is assembled. It also ensures that the body 18 and the part 22 are correctly orientated with each other. In another variation the male formations could be on the body 18 and the female formations on the leading mounting part 22. Further it will readily be appreciated that many other contrivances for effecting this detachable attachment could also be used.

FIGS. 6 and 6A show a lure movement altering body that is a variation on the movement altering body shown in FIG. 5.

In these drawings the movement altering body, which is indicated by reference numeral 74, has a leading face 76 that slants transversely in a way that is characteristic of a konahead-type lure head.

FIGS. 7 and 7A show a lure movement altering body that is another variation on the movement altering body shown in FIG. 5.

In these drawings the movement altering body which is indicated by the reference numeral 78 includes a leading face 80 that is axially inwardly concave in a way that is characteristic of a chugger-type lure head.

Further the lure may include other movement altering bodies that have not been illustrated such as bullet head-type lure head or a tube-type lure head.

In use the fishing lure 10 can be used in conventional game fishing activities. The lure 10 is attached to the end of a fishing line 14. To do this an angler threads a terminal end of the fishing line 14 through the various passages 39, 51 for receiving fishing line 14 in the leading and trailing parts of the lure mounting arrangement. The terminal end of the fishing line 14 terminates amongst the tentacle-like formations 28 and is attached to a fishing hook (not shown).

A user then selects a movement altering body 18 for use with the lure 10 and detachably mounts it on the lure mounting arrangement 12. The mounting method is illustrated schematically in FIG. 8.

The movement altering body 18 is first passed over the fishing line 14 so that the line 14 is received within the body passage 20. This is done by passing the fishing line 14 laterally or transversely in through the longitudinal fishing line opening 21. The opening is sized so that the line 14 can be manually passed through the opening 21.

The movement altering body 18 is then slid along the fishing line 14 over the spigot 32 until the spigot 32 is fully received in the socket 64 and the complementary clip formations 97, 98 engage each other. The fishing lure 10 is then assembled and ready for use. During fishing activities the lure 10 is dragged through the water where it mimics a bait fish. The shape and configuration of the movement altering body 18 influences the nature and manner of movement of the lure 10 in the water. Different movement altering bodies 18 are efficacious for catching different types of fish and are suited to certain conditions.

While fishing an angler may wish to change the fishing characteristics of their lure and they can quickly and easily do this by removing the existing movement altering body 18 and replacing it with a new body 18. The existing movement altering body 18 is first removed in a reverse process to the mounting process described above. That is the movement altering body 18 is slid off the spigot 32 on the lure mounting arrangement 12 by translational movement in a longitudinal direction as shown in FIG. 8. At this point the movement altering body 18 will enclose the fishing line 14 which is received within the body passage 20. The fishing line 14 can then be passed through the fishing line opening 21 to detach the body 18 from the remainder of the lure 10. This is accomplished by movement of the body 18 in a lateral direction as shown in FIG. 8.

Thereafter a new movement altering body 18 with different properties to the removed body 18 can be selected and mounted on the lure 10. This is done in the manner described above and illustrated in FIG. 8. It will be readily appreciated that it is not necessary to disconnect the entire fishing lure 10 including trace and hook and then exchange it with another fishing lure 10.

FIGS. 9 to 11 schematically illustrate a fishing lure in accordance with another embodiment of the invention. Unless otherwise indicated the same reference numerals will be used to refer to the same components as in the earlier embodiment. The following description will focus on the differences between this embodiment and the earlier embodiment.

As with the earlier embodiments the lure 10 comprises broadly a lure mounting arrangement 12 and a movement altering body 79.

The lure mounting arrangement 12 includes a leading mounting part 22 and a trailing mounting part 24. The leading mounting part 22, which is illustrated in FIG. 10, is formed by a spigot 32 having a spigot leading end 34 and a spigot trailing end 36 similar to the FIG. 1 embodiment. In this embodiment the leading mounting part 22 also includes a tubular projection 91 that projects substantially axially away from the leading end 34 thereof. The tube passage defined by the projection 91 forms part of the spigot passage 39 that receives fishing line 14. When the lure is assembled the projection 91 is received within the body passage 20 of the body 18.

In FIG. 10 the spigot 32 of the leading mounting part 22 comprises a two component construction comprising an inner support 93 and an outer cover 92 which is mounted over the inner support 93. The outer cover 92 is open at one end to enable it to be slid over the inner support 93 in the manner shown in the drawings. The outer cover 92 also has a small aperture 94 at the other end thereof through which the stub 90 protrudes. Conveniently the outer cover 92 can be made of a transparent material.

The outer cover 92 can be held in place mounted on the inner support 93 by magnets located on each of the outer cover 92 and the inner support 93. In the drawings these magnets are indicated by the reference numeral 101.

The spigot 32 can be encased in a reflective tape 95 to enhance the image of the eye depicting formations 48. The reflective tape 95 can be conveniently fixed to the spigot 32 by an adhesive, or by ultrasonic welding. Ultrasonic welding is frequently used for plastic materials and applies high-frequency ultrasonic acoustic vibrations to work pieces that are held together under pressure to create a solid-state weld. The reflective tape 95 could have a holographic image printed or otherwise formed thereon that changes as the position and orientation of the viewer changes. This makes the holographic image appear three dimensional.

The lure movement altering body will now be described with reference to FIGS. 11 and 11A.

The lure movement altering body, which is indicated generally by the reference numeral 79, is substantially cylindrical and has a leading face and a trailing face. In this embodiment the fishing line opening indicated by reference numeral 82 has a curved shape, e.g. an S-shape, which is different to the linear fishing line opening in the body 18 shown in FIG. 5. This shape of fishing line opening confers some advantages during use of the fishing lure.

As illustrated the swivel is formed by an annular roller bearing 60. The bearing 60 includes an outer race that is shaped and sized to be press fitted into the circular depression 52 and an inner race of the roller bearing 60 defining an opening within which the stub 90 is press fitted

The lure movement altering body 79 in the drawings also shows an arrangement of three radial spaced jet heads 99 defined in the body 79. The jet heads 99 comprise through flow passages through which water can pass, in use, when a lure 10 on which the body 79 is mounted is dragged through the fishing water. The jet heads 99 can produces a stream of bubbles in the water behind the lure 10 that can assist lure performance.

The lure in FIG. 9 also has a positive connector that utilises magnets for connecting the lure movement altering body 79 to the lure mounting arrangement 12. The connector comprises magnetic strips on each of the body 79 and the trailing part 24 that are magnetically attracted to each other. In FIGS. 9 to 11 the trailing part 24 has several magnetic strips 100 on an end face thereof, and an end face of the inner surface of movement altering body 79 has several complementary magnetic strips 100 thereon.

In use the FIG. 9 embodiment is used in much the same way as the FIG. 1 embodiment. As described above a further advantage of the FIG. 9 embodiment with the fishing line opening 82 is that in use, the curved shape of the fishing line opening 82 helps to retain the fishing line within the movement altering body 79.

The applicant also has a lure that is a variation on the lure shown in the FIG. 9 embodiment. In the variation the bearing 60 is omitted and the leading mounting part 22 is fixed to the trailing mounting part 24 so that they are held together fast with each other. The leading and trailing mounting parts 22 and 24 are designed slightly differently so that the stub 90 is fixedly received with the recess 52 on the part 24.

Apart from the fact that the leading mounting part and trailing mounting part cannot move relative to each other this variation functions in the same way as the FIG. 9 embodiment. As the drawing of this variation would be basically the same as the drawing of the FIG. 9 embodiment it has not been redrawn.

An advantage of the lure described above with reference to the drawings is that a user can easily and relatively quickly exchange one movement altering body with another such body to alter the movement of the fishing lure in the water. The lure movement altering bodies can be quickly and easily removed from the lure without disconnecting the entire fishing lure including trace and hook and then be replaced with another movement altering body.

The lure movement altering bodies can be shaped so that the lures described above with reference to the drawings function in the same way as known fishing lure heads. These lures can therefore be used in a conventional way for conventional reeling and trolling techniques.

A related advantage of the lure described above is that it is costly for an angler to equip themselves with a full set of lures as they have to buy a complete lure for each of the different lure shapes and lure sizes that they require. An arrangement for assembling a fishing lure described above with reference to the drawings includes a range of movement altering bodies that are mountable/demountable on a single lure mounting arrangement. Consequently this arrangement can be supplied to a user at a much lower cost than a full set of known lures.

Yet another advantage of some embodiments of the lure described above with reference to the drawings is that the movement altering body is operatively able to swivel relative to the trailing mounting part of the mounting arrangement. This enables it to rotate or spin as the lure moves through the water. Applicant believes that this can enhance the efficacy or performance of the lure.

It will of course be realised that the above has been given only by way of illustrative example of the invention and that all such modifications and variations thereto, as would be apparent to persons skilled in the art, are deemed to fall within the broad scope and ambit of the invention as is herein set forth.

1-28. (canceled)

29. A fishing lure, including:
a lure mounting arrangement for attaching to a fishing line;
a lure movement altering body for influencing movement of the lure when it is displaced through water, that is detachably mountable on the lure mounting arrangement, the lure movement altering body having an outer surface and defining a longitudinally extending body passage therein, and a longitudinal fishing line opening communicating with the body passage that opens onto the outer surface thereof; and
wherein the movement altering body, is mountable on and dismountable from, the lure mounting arrangement by a movement that is transverse to the longitudinal direction of the body passage, and wherein a fishing line that is operatively coupled to the lure mounting arrangement can be passed through the fishing line opening into or out of the body passage when the movement altering body is mounted on or dismounted from the lure mounting arrangement.

30. A lure according to claim 29, wherein the movement altering body includes two opposing end walls and a side wall extending between the end walls, and the body passage has body passage openings that open onto each end wall.

31. A lure according to claim 30, wherein the fishing line opening extends substantially the full length of the side wall and also extends across the end walls to the body passage openings whereby to enable the fishing line that is positioned outside of the movement altering body to be inserted through the fishing line opening into the body passage with the fishing line projecting out of the fishing line openings at the ends of the body.

32. A lure according to claim 31, wherein the fishing line opening extends in a curved line along the side wall.

33. A lure according to claim 29, wherein the lure mounting arrangement defines a mounting formation on an outward facing surface on the lure mounting arrangement, the movement altering body forms a complementary engagement formation along at least part of an inward facing surface of at least part of the body passage within which the mounting formation can be snugly received.

34. A lure according to claim 33, wherein the mounting formation comprises a spigot and the complementary engagement formation comprises a socket that receives the spigot wherein the mounting formation and the complementary engagement formation has complementary clip formations for detachably clipping the formations together when the mounting formation is fully received within the complementary engagement formation.

35. A lure according to claim 34, wherein the lure mounting arrangement includes a leading mounting part, and a trailing mounting part, and the leading and trailing mounting parts are coupled to each other in a way that they are capable of movement relative to each other, wherein the leading mounting part defines a leading part passage there through and the trailing mounting part defines a trailing part passage there through, and the leading and trailing part passages are aligned with each other so that the fishing line can be passed there through.

36. A lure according to claim 35, wherein the lure mounting arrangement includes a swivel operatively coupling the leading mounting part to the trailing mounting part, whereby the leading mounting part and the trailing mounting part may be capable of swivelling relative to each other about a swivelling axis, and optionally or preferably the lure mounting arrangement includes a bearing interposed between the trailing and leading mounting parts whereby to permit the parts to swivel freely relative to each other.

37. A lure according to claim 36, wherein the leading mounting part forms the spigot which engages with the socket on the movement altering body, and the spigot has a spigot leading end and a spigot trailing end and two major surfaces extending between the leading end and the trailing end, the leading mounting part includes two transversely outward facing eye depicting formations that are mounted on the major surfaces of the spigot, and wherein the fishing lure includes an elongated flexible lure portion that is attached to the trailing mounting part, wherein the spigot comprises a two component construction comprising an inner support and an outer cover which is mounted over the inner support.

38. A lure according to claim 29, wherein the movement altering body is chosen from any one of the following group including:
a generally circular cylindrical body having a leading face and a trailing end, and a mouth of the socket opening at the trailing end of the movement altering body;
a body which bulges in a radial outward direction so that a leading end portion of the movement altering body converges or tapers inwardly towards the leading face;
a leading face that bulges axially outwardly, so that the outer surface of the movement altering body is shaped in a way that is characteristic of an offshore bullet head-type lure head;
a leading face that slants transversely, so that the outer surface of the movement altering body is shaped in a way that is characteristic of a tube-type lure head;
a leading face that slants transversely and a front end portion that converges towards the front face, so that the outer surface of the movement altering body is shaped in a way that is characteristic of a konahead-type lure head;
a leading face that is axially inwardly concave, so that the outer surface of the movement altering body is shaped in a way that is characteristic of a chugger-type lure head; and
a leading face that is transversely orthogonally flat, so that the outer surface of the movement altering body is shaped in a way that is characteristic of a pusher-type lure head.

39. A lure movement altering arrangement for a fishing lure including, a lure mounting arrangement that is attachable to a fishing line, the lure movement altering arrangement including:
a lure movement altering body for influencing movement of the lure when it is displaced through water, that is detachably mountable on the lure mounting arrangement, the lure movement altering body having an outer surface and defining a longitudinally extending body passage therein, and a longitudinal fishing line opening communicating with the body passage that opens onto the outer surface thereof; and
wherein the movement altering body, is mountable on and dismountable from, the lure mounting arrangement by a movement that is transverse to the longitudinal direction of the body passage, and wherein a fishing line that is operatively coupled to the lure mounting arrangement can be passed through the fishing line opening into or out of the body passage when the movement altering body is mounted on or dismounted from the lure mounting arrangement.

40. A lure movement altering arrangement according to claim 39, wherein the lure movement altering body includes two opposing end walls and a substantially cylindrical side wall extending between the end walls, and the body passage has body passage openings that open onto each end wall, and the fishing line opening extends substantially the full length of the side wall and across the end walls to the body passage into which it opens, whereby to enable a fishing line that is positioned outside of the movement altering body to be inserted through the fishing line opening into the body passage with the fishing line projecting out of the fishing line openings at the ends of the body, wherein the fishing line opening extends in a non-linear fashion along the side wall substantially the full length of the side wall.

41. A lure mounting arrangement for a fishing lure having a lure movement altering body having an outer surface and defining a longitudinally extending body passage therein, and having a longitudinal fishing line opening communicating with the body passage and opening onto the outer surface thereof, the lure mounting arrangement including:
a mounting formation that is receivable within a complementary engagement formation formed by at least part of the body passage.

42. A lure mounting arrangement according to claim 41, wherein the lure mounting arrangement includes a leading mounting part defining said mounting formation and a trailing mounting part, and the leading and trailing mounting parts are coupled to each other in a way that they are capable of movement relative to each other.

43. A lure mounting arrangement according to claim 42, wherein the lure mounting arrangement includes a swivel operatively coupling the leading mounting part to the trailing mounting part, whereby the leading mounting part and the trailing mounting part are capable of swiveling relative to each other about a swiveling axis.

44. For a fishing lure comprising a lure mounting arrangement that is mounted on a fishing line, and a lure movement altering body that is detachably mounted on the lure mounting arrangement, the lure movement altering body has a longitudinally extending body passage defined therein and an outer surface with a longitudinal fishing line opening defined therein, there is provided a method of modifying the movement of the fishing lure through water during fishing, including:
detaching said movement altering body from the lure mounting arrangement includes passing the fishing line through the fishing line opening; and
detachably mounting a different movement altering body on the lure mounting arrangement includes passing the fishing line in through the fishing line opening, whereby to modify the manner in which the fishing lure moves when displaced through water;

45. A method of modifying the movement of a fishing lure through water according to claim 44, wherein detaching said one lure movement altering body from the lure mounting arrangement also includes displacing the lure movement altering body in a translational fashion in a direction away from the lure mounting arrangement.

46. A method of modifying the movement of a fishing lure through water according to claim 45, wherein mounting said other lure movement altering body on the lure mounting arrangement includes displacing the lure movement altering body in a translational fashion in a direction towards the lure mounting arrangement.

47. A method of modifying the movement of a fishing lure through water according to claim 46, wherein the other lure movement altering body and the lure mounting arrangement have complementary clip formations, and mounting said other lure movement altering body on the lure mounting arrangement includes displacing the lure movement altering body in a translational fashion towards the lure mounting arrangement until the complementary clip formations engage each other.

48. A method of modifying the movement of a fishing lure through water according to claim 47, wherein detaching said one lure movement altering body from the lure mounting arrangement includes detaching a body chosen from the group including:
a generally circular cylindrical body having a leading face and a trailing end, and a mouth of the socket opening at the trailing end of the movement altering body;
a body which bulges radially outwardly so that a leading end portion of the movement altering body converges or tapers inwardly towards the leading face; a leading face that bulges axially outwardly, so that the outer surface of the movement altering body is shaped in a way that is characteristic of an offshore bullet head-type lure head;
a leading face that slants transversely, so that the outer surface of the movement altering body is shaped in a way that is characteristic of a tube-type lure head;
a leading face that slants transversely and a front end portion that converges towards the front face, so that the outer surface of the movement altering body is shaped in a way that is characteristic of a konahead-type lure head;
a leading face that is axially inwardly concave, so that the outer surface of the movement altering body is shaped in a way that is characteristic of a chugger-type lure head; and
a leading face that is transversely orthogonally flat, so that the outer surface of the movement altering body is shaped in a way that is characteristic of a pusher-type lure head; and
wherein detachably mounting said other lure movement altering body on the lure mounting arrangement includes detachably mounting a body that is different to said one body detached from the lure mounting arrangement.
